(19) United States
(12) Patent Application Publication
(10) Pub. No.: US 2025/0297561 A1
(43) Pub. Date: Sep. 25, 2025

(54) PUMP ELEMENT FOR LUBRICANT

(71) Applicant: SKF Lubrication Systems Germany GmbH, Walldorf (DE)

(72) Inventors: Steffen Helmut SIEGEMUND, Wiesloch (DE); Cem KANTARCI, Walldorf (DE)

(21) Appl. No.: 19/081,357

(22) Filed: Mar. 17, 2025

(30) Foreign Application Priority Data
Mar. 22, 2024 (DE) 102024202732.4

(51) Int. Cl. F01M 11/02; F01M 1/02

(52) U.S. Cl. CPC F01M 11/02; F01M 1/02; F01M 2001/023

(57) ABSTRACT

A pump element (1), such as a piston pump element, for conveying lubricant. The pump element (1) can be fitted in a pump unit. The pump element (1) has a first housing portion (2) and a second housing portion (4). The first housing portion (2) moves into engagement with the pump unit. The second housing portion (4) receives lubricant through a lubricant inlet (32) and conveys the received lubricant to a lubricant outlet (14, 46). The first housing portion (2) and the second housing portion (4) are in the form of separate elements.

### CROSS-REFERENCE TO RELATED APPLICATION

This application claims priority to German Application No. 102024202732.4, filed Mar. 22, 2024, the entirety of which is hereby incorporated by reference.

### FIELD

The present disclosure relates to a pump element for lubricant according to the preamble of patent claim 1.

### BACKGROUND

It is generally necessary, when components which are movable relative to each other meet each other, as is the case, for example, in a bearing, and/or are exposed to friction in some other way, to supply the movable components or other lubricant consumers or friction locations with lubricant in order to reduce the wear at these components and/or to increase the service-life of the components. In order to provide the lubricant at the different consumers or friction locations, there may generally be used a pump unit which conveys the lubricant via lubrication lines to the corresponding lubrication locations by means of one or more pump elements.

Generally, the pump element is produced from a single piece of raw material and has at least one connection via which the pump element can be connected to a lubrication location via a lubricant line and a conveying chamber into which the lubricant is drawn via a suction line and is subsequently conveyed from the lubricant to the connection. Since the body of the pump element comprises a single piece of raw material, it is further necessary to introduce geometric and functional elements, such as, for example, the type of connection and/or its position in the pump element, one or more valve seats for receiving valves in the pump element, etc., into this basic body. Furthermore, the conveyed volume of lubricant substantially depends on the volume of the conveying chamber, which ultimately leads to a considerable number of pump element variants.

Furthermore, as a result of the complexity of the pump element, additional processing steps, such as, for example, a coating of the pump element or the assembly of the pump element, may be intensive in terms of work and/or costs. In addition, an adjustment operation may also be necessary.

Therefore, an object of the present disclosure is to provide a pump element for lubricant which is simple and cost-effective to produce.

### SUMMARY

This object is achieved by a pump element for lubricant according to patent claim 1.

A pump element, in particular piston pump element, for conveying lubricant is provided below. The pump element is particularly configured to be fitted in a pump unit. The pump unit can further have a lubricant container and a drive which is configured to drive the pump element in order to convey the lubricant. The lubricant may be, for example, a lubricating grease and/or a lubricating oil.

The pump element further has a first housing portion and a second housing portion, wherein the first housing portion is configured to move into engagement with the pump unit and the second housing portion is configured to receive lubricant through a lubricant inlet and to convey the received lubricant to a lubricant outlet. The first housing portion may further also have a lubricant outlet which is fluidically connected to the lubricant outlet and which is configured to be able to be connected to a lubricant line in order to guide the lubricant to a lubrication location. Alternatively, the lubricant outlet may also be able to be connected to an additional lubricant outlet of an additional pump element in order thus to increase a conveyed quantity of lubricant.

Furthermore, the second housing portion may have the conveying chamber into which the lubricant is drawn by the lubricant inlet. The lubricant inlet can be an opening which is formed in the second housing portion. For example, the opening may be a bore. This allows simple and cost-effective production for the lubricant inlet.

In order to provide a pump element which is simple and cost-effective to produce, the first housing portion and the second housing portion are in the form of separate elements. This allows the complexity of at least one housing portion to be reduced. Thus, for example, one and the same first housing portion can be combined with different second housing portions so that the conveying volume can be adapted by means of the second housing portion in order to provide a pump element with another conveying volume. For example, a second housing portion can be used with a greater conveying volume or with a conveying chamber which has a greater volume if a greater lubricant quantity is intended to be conveyed. In that the first housing portion and the second housing portion are in the form of separate elements, it may advantageously also become possible for the pump element, unlike the prior art, to be able to be mounted completely from one side so that a complex assembly operation can be dispensed with.

The first and second housing portions can be produced from the same material. Alternatively, the first and second housing portions can be produced from different materials. In particular, as a result of the two separate housing portions, it is possible to produce the second housing portion, which is often exposed to greater loading as a result of conveying the lubricant, from a more resistant material and thereby to improve the reliability of the pump element. Since the first housing portion is usually exposed to smaller loads than the second housing portion, the first housing portion can be produced from a more cost-effective material so that the costs for the pump element can be reduced.

Preferably, the first housing portion can be produced from metal, for example a steel, light metal, light metal alloys and/or from plastics material, in particular fibre-reinforced plastics material. This allows the costs for the first housing portion to be reduced. Furthermore, the second housing portion can be produced from metal, for example, steel, so that a second housing portion which can withstand the loads which are produced by conveying the lubricant can be provided.

Furthermore, the first housing portion and the second housing portion can be releasably connected to each other. This allows simple and rapid replacement of the second housing portion so that, for example, adaptation of the conveyed lubricant volume can be carried out rapidly and simply by the second housing portion being exchanged. For example, the first housing portion and the second housing portion can be connected to each other in a non-positive-locking manner. In particular, the first housing portion and the second housing portion can be connected with a screw connection. Alternatively, the first housing portion and the second housing portion can also be connected via a clamp connection, a press-fit, a bayonet connection or the like. A non-positive-locking connection, in particular a screw connection, allows the first housing portion and the second housing portion to be connected to each other reliably and also released from each other again. In particular, for example, it can be ensured via a defined torque when tightening the screw connection that the first housing portion and the second housing portion are sufficiently securely connected to each other.

Furthermore, the first housing portion can be brought into engagement with the pump unit in a releasable manner. This allows the pump element to be mounted and/or disassembled rapidly and simply on/from the pump unit. For example, the first housing portion and the pump unit can be connected to each other in a non-positive-locking manner. In particular, the first housing portion and the pump unit can be connected with a screw connection. Alternatively, the first housing portion and the pump unit can also be connected via a clamp connection, a press-fit, a bayonet connection or the like. This allows a reliable connection which can also be released again rapidly and simply to be provided between the first housing portion and the pump unit.

According to another preferred embodiment, the first housing portion has at least a first cylindrical portion which is provided with a bore which extends at least partially through the first cylindrical portion, wherein an outer covering face of the first cylindrical portion is configured to move into engagement with the pump unit and an inner covering face of the first cylindrical portion is configured to move into engagement with the second housing portion. Advantageously, the outer covering face can be provided with a thread. This allows the first housing portion to be connected to the pump unit rapidly and simply. Alternatively or additionally, the inner covering face can be provided with a thread so that the second housing portion can be connected to the first housing portion simply and rapidly.

Preferably, the second housing portion has at least one second cylindrical portion which is provided with a bore which at least partially extends through the second cylindrical portion, wherein an outer covering face of the second cylindrical portion is configured to move into engagement with the first housing portion. Advantageously, the outer covering face can be provided with a thread. This allows the second housing portion to be connected to the first housing portion rapidly and simply. For example, the second housing portion can be screwed into the first housing portion.

Furthermore, the bore of the second housing portion can be configured to receive a piston which is configured to convey the lubricant out of the lubricant outlet during movement in a first direction and, during movement in a second direction counter to the first direction, to receive the lubricant through the lubricant inlet. The lubricant can be conveyed in a reliable manner by the piston.

Furthermore, a non-return valve can advantageously be received at least partially in the bore of the first housing portion. The non-return valve can be configured to connect the lubricant inlet to the movement region of the piston in technical fluid terms during a movement of the piston in the second direction. During a movement of the piston in the first direction, the lubricant inlet is separated from the movement region of the piston in technical fluid terms. Thus, for example, it may become possible for the lubricant to be able to be drawn through the lubricant inlet during a movement of the piston in the second direction, but not to be brought out of the lubricant inlet during a movement of the piston in the first direction, but instead through the lubricant outlet.

Furthermore, the pump element may, for example, also comprise a non-return valve which is configured to connect the lubricant outlet during a movement of the piston in the first direction to the movement region in technical fluid terms and, during a movement of the piston in the second direction, to separate the lubricant outlet and the movement region of the piston in technical fluid terms. In some exemplary embodiments, a suction or conveying power of the pump with the pump element can thus be increased.

According to another advantageous embodiment, an outer covering face of the second housing portion has in an axial direction at least one step which is in the form of a stop for an end face of the first housing portion and/or an inner covering face of the first housing portion has in an axial direction of the bore at least one step which is in the form of a stop for an end face of the second housing portion. The provision of a stop allows the first and second housing portions to be connected to each other in a defined manner so that an adjustment operation for the pump element can be dispensed with. It is thereby possible to further reduce the working steps necessary when assembling the pump element and consequently to reduce the costs for the pump element. For example, when the first and second housing portions are connected to each other via a screw connection, a stop can ensure that the second housing portion is screwed sufficiently further into the first housing portion in order to achieve a secure connection of the first and second housing portions. As a result of the stop, automated assembly of the pump element can also be enabled since it is possible to establish in an automated manner whether the second housing portion is screwed sufficiently far into the first housing portion. For example, by the torque which is required being measured. Furthermore, the stop can also ensure that, when the second housing portion is screwed into the first housing portion, a length of the conveying chamber and thereby a volume of the conveying chamber is always the same if identical second housing portions are used so that an adjustment operation can be dispensed with.

Furthermore, at least one sealing apparatus can be provided between the first housing portion and the second housing portion. Preferably, the at least one sealing apparatus comprises an elastomer sealing means and/or a metal sealing means. This has the advantage that a fluid-tight connection between the first and second housing portions can be provided in a simple manner.

Preferably, the end face of the second housing portion and/or the step of the first housing portion is provided with a cutting edge which is configured to form a fluid-tight connection between the step and the end face. This has the advantage that a fluid-tight connection between the first and second housing portion can also be provided without a separate sealing means. If the first housing portion and the second housing portion are produced from different materials, the cutting edge is advantageously formed on the harder of the two materials. The cutting edge which is formed from the harder material can thereby cut more easily into the softer material and thus provide a better seal between the two housing portions.

Advantageously, if the first housing portion and the second housing portion are produced from different metals, wherein the housing portion which is produced from the harder metal is provided with the cutting edge, a pump element which can also be exposed to relatively high temperatures can be provided, in particular temperatures above 80° C., since an elastomer sealing element can be dispensed with by providing the cutting edge.

According to another aspect, a pump unit which is provided with at least one above-described pump element, a lubricant container and at least one drive is further provided, wherein the drive is configured to drive the pump element so that lubricant can be conveyed by the pump element.

Additional advantages and advantageous embodiments are set out in the description, the drawings and the claims. In this instance, in particular the combinations, set out in the description and in the drawings, of the features are purely exemplary so that the features may also be present individually or combined in other ways.

### BRIEF DESCRIPTION OF THE DRAWINGS

The present disclosure is intended to be described in greater detail below with reference to exemplary embodiments illustrated in the drawings. In this case, the exemplary embodiments and the combinations set out in the exemplary embodiments are purely exemplary and are not intended to determine the scope of protection of the present disclosure. This scope of protection is defined only by the appended claims. In the drawings:

FIG. 1: shows a pump element for lubricant according to a first embodiment,

FIG. 2: shows the detail II of FIG. 1,

FIG. 3: shows a pump element for lubricant according to a second embodiment, and

FIG. 4: shows a pump element for lubricant according to a third embodiment.

### DETAILED DESCRIPTION

Identical or functionally equivalent elements are denoted with the same reference numerals below.

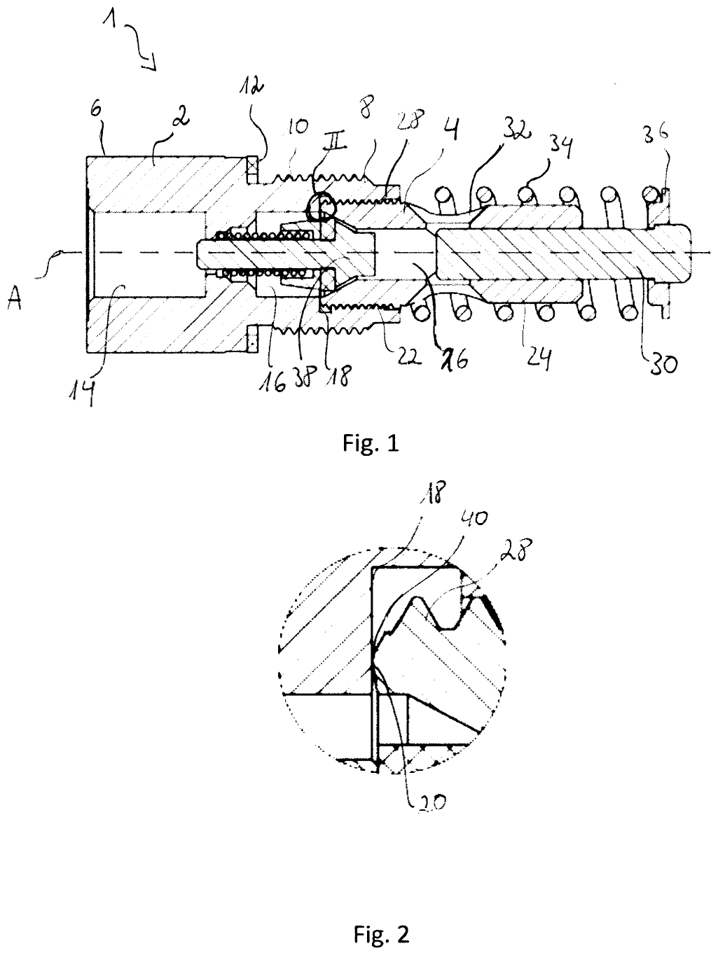

With reference to FIGS. 1 and 2, a pump element 1 for conveying lubricant according to a first embodiment is shown. The lubricant may be, for example, a lubricating grease and/or a lubricating oil. For example, the pump element 1 can be fitted in a pump unit, wherein the pump unit further has a lubricant container which contains the lubricant to be conveyed and a drive which is configured to drive the pump element 1 in order to convey the lubricant.

The pump element 1 comprises a first housing portion 2 and a second housing portion 4. The first housing portion 4 has a first cylindrical portion 6 and a second cylindrical portion 8, wherein an outer covering face of the second cylindrical portion 8 is provided with a thread 10 which is configured to move into engagement with the pump unit so that the pump element 1 can be releasably secured to the pump unit by means of the first housing portion 2. Furthermore, in the exemplary embodiment illustrated, a step 12 which acts as a stop for the pump element when it is secured to the pump unit is provided between the first and second cylindrical portions 6, 8 of the first housing portion 2.

Furthermore, the first cylindrical portion 6 is provided with a first bore 14 and the second cylindrical portion 18 is provided with a second bore 16, wherein the first bore and the second bore are connected to each other in fluid terms. In the pump element 1 illustrated in FIG. 1, the first bore 14 is in the form of a lubricant outlet which can be connected to a lubricant line in order to guide the lubricant to a lubrication location.

The inner covering face of the second bore 16 of the first housing portion 2 has in an axial direction A a step 18 which is in the form of a stop for an end face 20 of the second housing portion 4. Furthermore, the inner covering face of the second bore 16 of the first housing portion 2 is partially provided with a thread 22 so that, as described below, the second housing portion 4 can be connected to the first housing portion 2 simply and rapidly.

The second housing portion 4 also comprises a cylindrical portion 24 which is provided with a bore 26 which extends partially through the cylindrical portion 24. A region of the outer covering face of the cylindrical portion 24 has a thread 28 which moves into engagement with the thread 22 which is formed on the inner covering face of the second bore 16 of the first housing portion 2 in order to connect the first housing portion 2 and the second housing portion 4 to each other.

Furthermore, the second housing portion 4 has a piston 30 and a through-opening 32 which is in the form of a lubricant inlet. The bore 26 acts here as a conveying chamber in which the lubricant is drawn through the lubricant inlet when the piston is moved in a first direction. During movement in a second direction counter to the first direction, the lubricant is conveyed in the direction of the first housing portion 2 and therefore in the direction of the lubricant outlet 14. In the pump element 1, the movement in the second direction is driven by a drive (not shown) which is in the form, for example, of an eccentric and the movement in the first direction is carried out by a restoring spring 34 which is compressed during the movement of the piston in the second direction between the first housing portion 2 and a stop 36 which is secured to the piston 30. Alternatively, another drive and restoring system for moving the piston in the first and second directions may be provided.

So that the lubricant from the lubricant outlet 14 does not flow back into the conveying chamber of the second housing portion 4 again, a non-return valve 38 is provided between the bore 16 and the lubricant outlet 14. In this case, the non-return valve 38 is arranged in such a manner that it connects the lubricant outlet 14 to the bore 26 or the conveying chamber during a movement of the piston 30 in the second direction in technical fluid terms. During a movement of the piston 30 in the first direction, the non-return valve 38 separates the lubricant outlet 14 from the bore 26 or the conveying chamber.

By conveying the lubricant, in particular the second housing portion 4 is often exposed to greater loading than the first housing portion 2. Therefore, the second housing portion 4 can be produced from a more resistant material so that the reliability of the pump element 1 can be improved. Since the first housing portion 2 is usually exposed to smaller loads than the second housing portion 4, the first housing portion 2 can be produced from a more cost-effective material so that the costs for the pump element 1 can be reduced.

As can be seen in FIG. 2, in order to provide a seal between the first and second housing portions 2, 4, an end face 20 of the second housing portion 4 is provided with a cutting edge 40 which, when the first and second housing portions 2, 4 are connected to each other, engages in the step 18 of the first housing portion 2.

Advantageously, the material of the second housing portion 4 can to this end be harder than the material of the first housing portion 2. The cutting edge 40 which is formed from the harder material can thereby cut more readily into the softer material and thus provide a better seal between the two housing portions 2, 4. For example, the second housing portion 4 is produced from metal, in particular steel, and the first housing portion 2 is produced from a light metal or a plastics material. Alternatively, the step 18 of the first housing portion 2 can be provided with the cutting edge 40. Furthermore, it is also conceivable for the step 18 of the first housing portion 2 and the end face 20 of the second housing portion 4 to be provided with a cutting edge 40 and a metal sealing means, such as, for example, a copper seal, to be inserted between the two cutting edges.

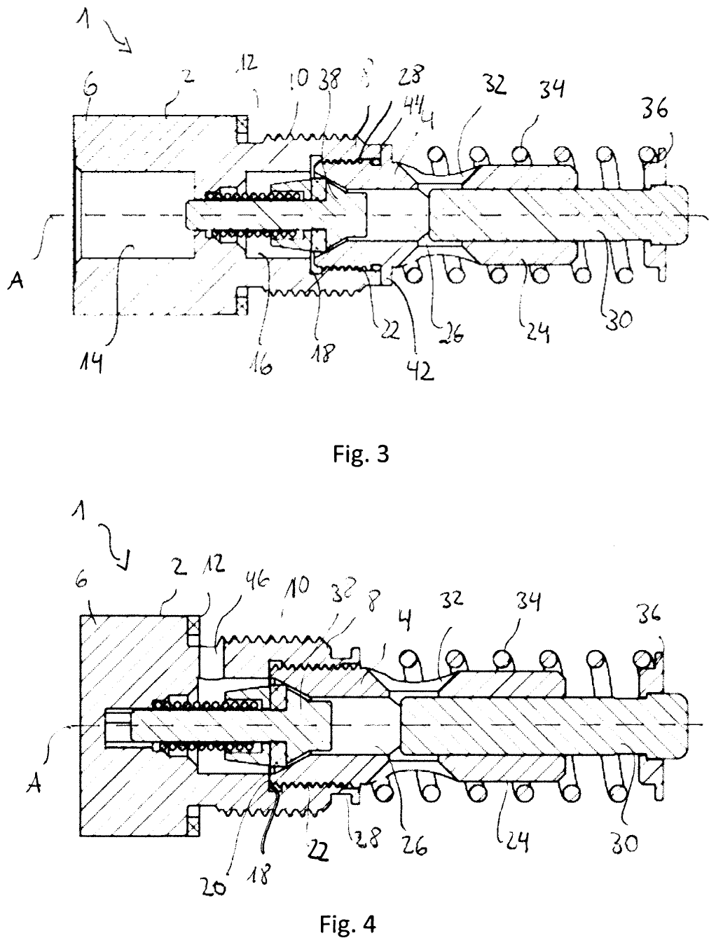

FIG. 3 illustrates a pump element 1 for lubricant according to a second embodiment. The pump element 1 according to the second embodiment differs from the pump element 1 of the first embodiment which is shown in FIGS. 1 and 2 in that no cutting edge 40 is formed on the end face 20 of the second housing portion 4. As can be seen in FIG. 3, in the pump element 1 of the second embodiment a gap is provided between the step 18 and the end face 20. In order nevertheless to provide a stop which ensures that the two housing portions 2, 4 are screwed sufficiently far in each other, in the pump element 1 of the second embodiment a projection 42 or step which acts as a stop for an end face 44 of the first housing portion 2 is formed on the outer covering face of the second housing portion 4.

In the pump element 1 of FIG. 3, the first and second housing portions 2, 4 can be produced from the same material or from a different material. Depending on the type of lubricant, a sealing element (not illustrated) can be inserted selectively between the end face 20 of the second housing portion 4 and the step 18 of the first housing portion 2 in order to improve a seal of the two housing portions 2, 4.

FIG. 4 illustrates a pump element 1 for lubricant according to the third embodiment. The pump element 1 according to the third embodiment differs from the pump element 1 of the first embodiment which is shown in FIGS. 1 and 2 in that the first housing portion 2 has only one bore 16 and the lubricant outlet is in the form of a bore 46 which extends perpendicularly to the axis A and which opens in the bore 16. Alternatively, the bore 46 can also extend obliquely, for example, at a 45° angle with respect to the axis A. For example, two pump elements 1 can be coupled to each other via the bore 46 and the provided lubricant quantity can be increased.

In summary, a pump element 1 which has two separate housing portions 2, 4 is provided. This allows the pump element 1 to be produced and/or assembled simply and cost-effectively. In particular, the pump element 1 can be mounted completely from one side so that a complex assembly operation can be dispensed with. For example, one and the same first housing portion 2 can be combined with different second housing portions 4 so that the conveying volume in the second housing portion 4 can be readily adapted in order to provide a pump element 1 with another conveying volume.

Furthermore, the described pump element can also be assembled in an automated manner so that the costs for production and/or the pump element can be further reduced.

As a result of the two separate housing portions 2, 4, it is also possible to produce the two housing portions 2, 4 from different materials so that the housing portion which is exposed to greater loads can be produced from a harder and/or tougher material and/or the housing portion which is exposed to smaller loads can be produced from a cheaper material so that the costs for the pump element can be reduced.

### LIST OF REFERENCE NUMERALS

1 Pump element
2 First housing portion
4 Second housing portion
6 Cylindrical portion
8 Cylindrical portion
10 Thread
12 Step
14 Bore
16 Bore
18 Step
20 End face
22 Thread
24 Cylindrical portion
26 Bore
28 Thread
30 Piston
32 Through-opening
34 Restoring spring
36 Stop
38 Non-return valve
40 Cutting edge
42 Projection
44 End face
46 Bore
A Axial direction

What is claimed is:

1. A pump element for conveying lubricant in a pump unit, the pump element comprising:
a first housing portion configured to move into engagement with the pump unit, the first housing portion having a lubricant outlet; and
a second housing portion having a lubricant inlet, the second housing portion being configured to receive lubricant through the lubricant inlet and to convey the received lubricant to the lubricant outlet;
the first housing portion and the second housing portion being in the form of separate elements, the pump element being configured to be fitted in the pump unit.

2. The pump element according to claim 1, wherein the first housing portion has at least a first cylindrical portion which is provided with a bore which extends at least partially through the first cylindrical portion, wherein an outer covering face of the first cylindrical portion is configured to move into engagement with the pump unit and an inner covering face of the first cylindrical portion is configured to move into engagement with the second housing portion.

3. The pump element according to claim 1, wherein the second housing portion has at least one second cylindrical portion which is provided with a bore which at least partially extends through the second cylindrical portion, wherein an outer covering face of the second cylindrical portion is configured to move into engagement with the first housing portion.

4. The pump element according to claim 1, wherein an outer covering face of the second housing portion has in an axial direction at least one step which is in the form of a stop for an end face of the first housing portion, and/or wherein an inner covering face of the first housing portion has in an axial direction of the bore at least one step which is in the form of a stop for an end face of the second housing portion.

5. The pump element according to claim 4, wherein an inner covering face of the first housing portion has in an axial direction of the bore a step which is in the form of a stop for an end face of the second housing portion, wherein the end face and/or the step is/are provided with a cutting edge which is configured to form a fluid-tight connection between the step and the end face.

6. The pump element according to claim 1, wherein at least one sealing apparatus is provided between the first housing portion and the second housing portion.

7. The pump element according to claim 6, wherein the at least one sealing apparatus comprises an elastomer sealing means and/or a metal sealing means.

8. The pump element according to claim 1, wherein the first housing portion and the second housing portion are produced from the same material or from a different material.

9. The pump element according to claim 1, wherein the first housing portion is made of metal and/or plastics material, and/or wherein the second housing portion is made of metal.

10. The pump element according to claim 1, wherein the first housing portion and the second housing portion are releasably connected to each other, and/or wherein the first housing portion can be brought into engagement with the pump unit in a releasable manner.

11. The pump element according to claim 1, wherein the first housing portion and the second housing portion are connected to each other in a non-positive-locking manner, and/or wherein the first housing portion is configured to connect to the pump unit in a non-positive-locking manner.

12. The pump element according to claim 2, wherein the second housing portion has at least one second cylindrical portion which is provided with a bore which at least partially extends through the second cylindrical portion, wherein an outer covering face of the second cylindrical portion is configured to move into engagement with the first housing portion.

13. The pump element according to claim 12, wherein an outer covering face of the second housing portion has in an axial direction at least one step which is in the form of a stop for an end face of the first housing portion, and wherein an inner covering face of the first housing portion has in an axial direction of the bore at least one step which is in the form of a stop for an end face of the second housing portion.

14. The pump element according to claim 13, wherein an inner covering face of the first housing portion has in an axial direction of the bore a step which is in the form of a stop for an end face of the second housing portion, wherein the end face and the step are provided with a cutting edge which is configured to form a fluid-tight connection between the step and the end face.

15. The pump element according to claim 14, wherein at least one sealing apparatus is provided between the first housing portion and the second housing portion.

16. The pump element according to claim 15, wherein the at least one sealing apparatus comprises an elastomer sealing means and/or a metal sealing means.

17. The pump element according to claim 16, wherein the first housing portion is made of metal and/or plastics material, and wherein the second housing portion is made of metal.

18. The pump element according to claim 17, wherein the first housing portion and the second housing portion are releasably connected to each other, and wherein the first housing portion can be brought into engagement with the pump unit in a releasable manner.

19. The pump element according to claim 18, wherein the first housing portion and the second housing portion are connected to each other in a non-positive-locking manner, and wherein the first housing portion is configured to connect to the pump unit in a non-positive-locking manner.
